(19) United States
(12) Patent Application Publication
(10) Pub. No.: US 2010/0279164 A1
(43) Pub. Date: Nov. 4, 2010

(54) ELECTRONIC DEVICE WITH BATTERY COVER LATCH

(75) Inventor: CHENG-JIE GAO, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/538,288

(22) Filed: Aug. 10, 2009

(30) Foreign Application Priority Data
Apr. 30, 2009 (CN) 200910302015.2

(51) Int. Cl. H01M 2/10

(52) U.S. Cl. 429/100

(57) ABSTRACT

An electronic device includes a main body, a holder, a battery cover, a button and a resilient member. The main body defines an opening and a protruding hole. The holder is fixed to the main body. The battery cover is coupled to the main body and forms a catching tab. The button is slidably positioned between the main body and the holder. The button includes a latching tab. One end of the resilient member resists the holder or the main body, and the other end resists the button. The catching tab of the battery cover protrudes in the protruding hole to engage with the latching tab of the button, and part of the button exposes out of the main body via the opening.

### BACKGROUND

1. Technical Field

The present disclosure generally relates to electronic devices, particularly, to an electronic device with a battery cover latch.

2. Description of Related Art

Electronic devices such as mobile phones and personal digital assistants (PDAs) are widely used. Rechargeable batteries are usually installed in electronic devices to supply electric power. When a battery is installed in an electronic device, it is generally secured in a battery receiving cavity and covered by a battery cover, thus the battery and the inner circuits of the portable electronic device are well protected. The battery cover is usually latched to the electronic device by a battery latch.

A typical electronic device includes a housing, a battery cover, a spring, and a button. The battery cover is coupled to the housing to further hold a battery in the housing. The button includes a shaft and a hook. The battery cover defines a hole to rotatably receive the button. The housing also has a hook defined to latch with the hook of the button, thus latching the battery cover to the housing. The spring is disposed between the button and the housing to automatically rotate the button once the hook of the button disengages from the hook of the housing.

However, having a hole in the battery cover is unaesthetic. A shaft hole should be defined in the battery cover to rotatably receive the shaft of the button. It is difficult to manufacture such a shaft hole, and increases manufacturing cost of the electronic device.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a partial, assembled, isometric view of an exemplary embodiment of an electronic device.

FIG. 2 is a part of an exploded, isometric view of the electronic device of FIG 1.

FIG. 3 is a part of an exploded, isometric view of the electronic device of FIG. 1, but viewed from another aspect.

FIG. 4 is a part of a cross-section of the electronic device of FIG. 1 taken along line V-V, showing a first state.

FIG. 5 is a part of a cross-section of the electronic device of FIG. 1 taken along line V-V, showing a second state.

### DETAILED DESCRIPTION

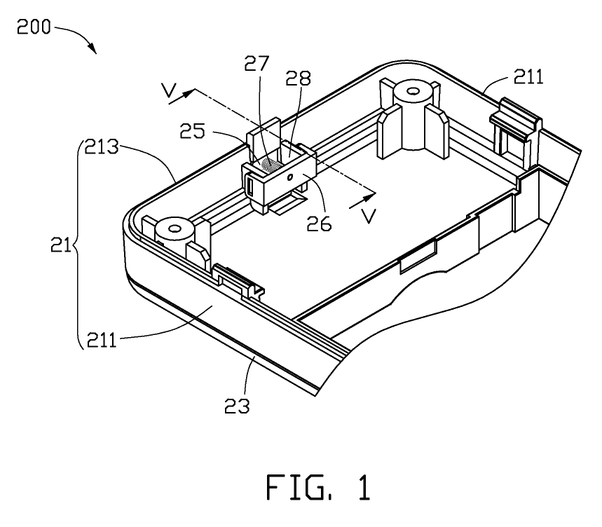

The present electronic device may be a mobile phone, a personal digital assistant, and others. Referring to FIG. 1, an exemplary embodiment of the electronic device 200 is described and illustrated as a mobile phone.

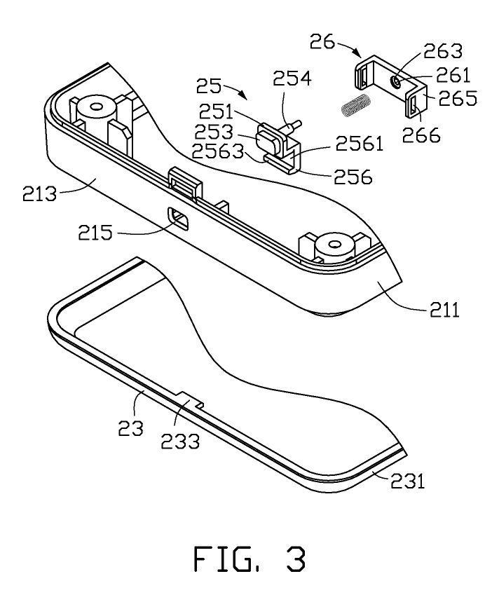

Referring to FIGS. 1 through 3, the electronic device 200 includes a main body 21, a battery cover 23, and a battery cover latch 24. The battery cover latch 24 includes a button 25, a holder 26, and a resilient member 27.

The main body 21 includes two opposite first sidewalls 211 and a second sidewall 213 with ends thereof connected to the first sidewalls 211. The main body 21 defines an opening 215 in the second sidewall 213. Two fixing pieces 216 are formed on an inner side of the second sidewall 213. The fixing pieces 216 are adjacent to the opening 215. Each fixing piece 216 forms a protrusion 2161 on a side facing the first sidewalls 211. The main body 21 further defines a protruding hole 218 adjacent to the opening 215 and forms a limiting plate 219 between the opening 215 and the protruding hole 218.

The battery cover 23 is to be coupled to the main body 21. The battery cover 23 forms a flange 231 at an edge thereof and a catching tab 233. The catching tab 233 extends inwards from the flange 231 of the battery cover 23. The catching tab 233 is positioned corresponding to the protruding hole 218 so that the catching tab 233 can insert in the protruding hole 218 when the battery cover 23 coupled to the main body 21.

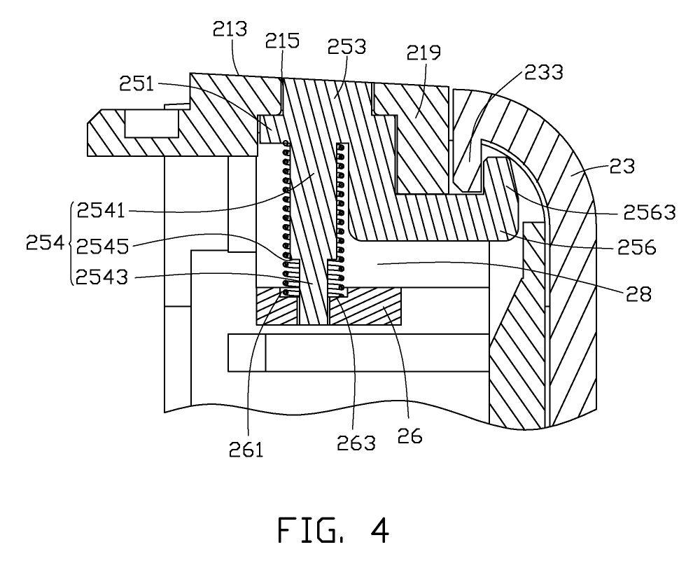

The button 25 includes a base 251, an operating portion 253, a guide pole 254, and a hook 256. The operating portion 253 and the guide pole 254 are formed at opposite sides of the base 251, and the hook 256 forms from an edge of the base 251. Referring to FIG. 4, the guide pole 254 includes a shaft portion 2541 connected to the base 251 and a slide portion 2543 formed at an end of the shaft portion 2541. The slide portion 2543 is smaller than the shaft portion 2541, thereby forming a step surface 2545 at a joint of the shaft portion 2541 and the slide portion 2543. The hook 256 defines a depression 2561 and includes a latching tab 2563 at an end thereof.

The holder 26 defines a guide hole 261 in a center, and a step 263 is formed in the guide hole 261. The holder 26 includes two connecting plates 265 at opposite ends thereof. Each connecting plate 265 defines a connecting hole 266 to engage with one of the protrusions 2161.

The protrusions 2161 of the main body 21 are engaged in the connecting holes 266 of the holder 26, to fix the holder 26 to the main body 21. Thereby, the second sidewall 213, the fixing pieces 216, and the holder 26 cooperatively forms a receptacle 28 to receive the button 25. During assembling the battery cover latch 24 to the main body 21, the button 25 is assembled to the main body 21 before the holder 26 to facilitate assembling. The resilient member 27 is sleeved on the shaft portion 254 of the button 25, and at least part of the slide portion 2543 inserts in the guide hole 261 of the holder 26. The button 25 can slide along the axis of the guide hole 261 until the step surface 2545 resists the step 263 of the holder 26 by pressing the button 25. The operating portion 253 of the button 25 exposes to an outside of the main body 21 via the opening 215 and the latching tab 2563 of the button 25 corresponds to the protruding hole 218 to engage with the catching tab 233 of the battery cover 23. Opposite ends of the resilient member 27 resist the base 251 of the button 25 and the holder 26 correspondingly.

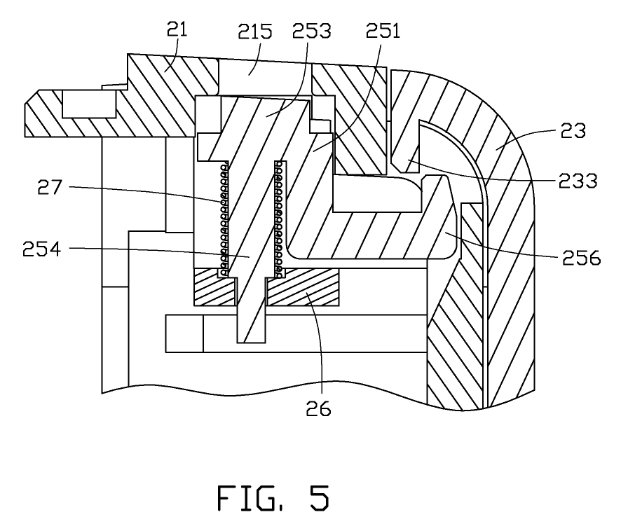

Referring to FIG. 5, to remove the battery cover 23 from the main body 21, the operating portion 253 of the button 25 is pressed to slide the button 25 towards the holder 26, the latching tab 2563 of the hook 256 of the button 25 disengages from the catching tab 233 of the battery cover 23, thus the battery cover 23 is detachable. In the process of pressing the button 25, the resilient member 27 is compressed.

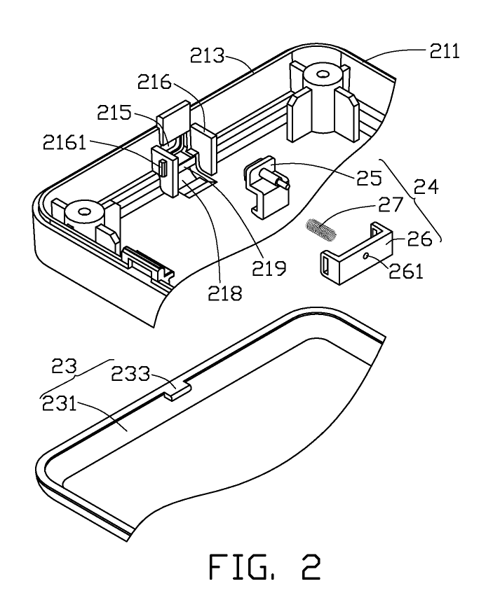

Referring to FIG. 2 and FIG. 5, to remove the battery 20 from the battery receptacle 30, when the switch portion 55 of the locking member 50 is actuated, the resisting portion 53 exits from the second locking slot 231.

The battery cover 23 may be removed from the main body 21 by only pressing the button 25, therefore, it is very convenient. No need to define any hole or slot in the battery cover 23, thus making the electronic device 200 have a nice appearance.

In alternative embodiments, the holder 26 may be fixed to the main body 21 by other manners, for example, the holder 26 and the main body 21 may be integrally formed. The whole or part of the operating portion 253 of the button 25 may protrude out of the main body 21 via the opening 215.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1 An electronic device, comprising:
a main body defining an opening and a protruding hole;
a holder fixed to the main body;
a battery cover to couple to the main body, the battery cover forming a catching tab;
a button slidably positioned between the main body and the holder, the button comprising a latching tab; and
a resilient member with one end resisting the holder or the main body and the other end resisting the button;
wherein the catching tab of the battery cover protrudes in the protruding hole to engage with the latching tab of the button, part of the button exposes out of the main body via the opening.

2. The electronic device of claim 1, wherein two fixing pieces are formed on an inner side of the main body, the fixing pieces are adjacent to opposite sides of the opening.

3. The electronic device of claim 2, wherein the holder is fixed to the fixing pieces; the fixing pieces and the holder cooperatively forms a receptacle to receive the button.

4. The electronic device of claim 3, wherein each fixing piece forms a protrusion, the holder forms two connecting holes to engage with the protrusions, thus fixing the holder to the main body.

5. The electronic device of claim 4, wherein the button comprises a base, an operating portion, a guide pole, and a hook; the operating portion exposes to the outside of the main body; the resilient member is sleeved on the guide pole.

6. The electronic device of claim 5, wherein the operating portion and the guide pole are formed at opposite sides of the base, and the hook forms from an edge of the base, the guide pole comprises a shaft portion connected to the base and a slide portion formed at an end of the shaft portion, the slide portion is smaller than the shaft portion, thereby forming a step surface at a joint of the shaft portion and the slide portion.

7. The electronic device of claim 6, wherein the holder defines a guide hole; the slide portion of the button inserts in the guide hole of the holder.

8. The electronic device of claim 5, wherein the latching tab is formed on the hook.

9. An electronic device, comprising:
a main body;
a battery cover to couple to the main body, the battery cover forming a catching tab;
a button comprising a latching tab; and
wherein part of the button exposes out of the main body, the button is movable so that the latching tab of the button is capable of engaging with or disengaging from the catching tab of the battery cover.

10. The electronic device of claim 9, wherein the main body defines an opening to allow the button exposing out of the main body; two fixing pieces are formed on an inner side of the main body, the fixing pieces are adjacent to opposite sides of the opening.

11. The electronic device of claim 10, wherein the holder is fixed to the fixing pieces; the fixing pieces and the holder cooperatively forms a receptacle to receive the button.

12. The electronic device of claim 11, wherein each fixing piece forms a protrusion, the holder forms two connecting holes to engage with the protrusions, thus fixing the holder to the main body.

13. The electronic device of claim 12, wherein the button comprises a base, an operating portion, a guide pole, and a hook; the operating portion exposes to the outside of the main body; the electronic device further comprises a resilient member sleeved on the guide pole.

14. The electronic device of claim 13, wherein the operating portion and the guide pole are formed at opposite sides of the base, and the hook forms from an edge of the base, the guide pole comprises a shaft portion connected to the base and a slide portion formed at an end of the shaft portion, the slide portion is smaller than the shaft portion, thereby forming a step surface at a joint of the shaft portion and the slide portion.

15. The electronic device of claim 14, wherein the holder defines a guide hole; the slide portion of the button inserts in the guide hole of the holder.

16. The electronic device of claim 14, wherein the latching tab is formed on the hook.
